(19) United States
(12) Patent Application Publication
(10) Pub. No.: US 2010/0159749 A1
(43) Pub. Date: Jun. 24, 2010

(54) CONNECTOR

(75) Inventor: Yoshihito Ohkuma, Yokohama-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: IRISO ELECTRONICS CO., LTD., Yokohama-shi (JP)

(21) Appl. No.: 12/160,821

(22) PCT Filed: Feb. 14, 2006
(86) PCT No.: PCT/JP2006/302556

§ 371 Date: Jul. 14, 2008

(51) Int. Cl. H01R 24/00

(52) U.S. Cl. 439/660

(57) ABSTRACT

A connector prevents a terminal from short circuiting when the terminal is elastically deformed with movement of a movable housing. The length in the width direction at one end of each terminal is larger than the length in the width direction at the other end, so the distance between the terminals at the other end is larger than the distance between the terminals at one end, thereby preventing adjacent terminals from contacting each other when movable terminal portions are elastically deformed.

### BACKGROUND OF THE INVENTION

1. Field of the Invention

The present invention relates to a connector for connecting a plurality of devices, such as for connecting a personal computer and an HDD (Hard Disk Drive).

2. Description of the Related Art

A known conventional connector of this type has included: a movable housing placed on the side of one object to be connected; a fixed housing placed on the side of the other object to be connected; and a plurality of terminals each having one end held by the movable housing and the other end held by the fixed housing, a movable portion formed between one end and the other end of each terminal being elastically deformed as the movable housing moves relative to the fixed housing in a width direction and a vertical direction.

Such a connector includes a plurality of terminals 30 as shown in FIG. 10 in a width direction of the connector. Each terminal 30 is formed by bending a conductive metal plate in a fore/aft direction (Y direction) and a vertical direction (Z direction), and includes a contact portion 31 that comes into contact with one object to be connected, a movable portion 32 elastically deformed in a width direction (X direction) and the vertical direction (Z direction) of the terminal 30, and a connecting portion 33 connected to the other object to be connected. A dimension (=X1) in the width direction of the contact portion 31 is larger than a dimension (=Z1) in the vertical direction of the contact portion 31, and a dimension (=X1) in the width direction of the movable portion 32 is larger than a dimension (=Y1) in the fore/aft direction of the movable portion 32.

However, in this connector, the dimension (=X1) in the width direction of the movable portion 32 is equal to the dimension (=X1) in the width direction of the contact portion 31, and thus a small interval is formed between the terminals 30 at the other end as at one end. Thus, when the movable housing is moved in the width direction (X direction), the movable portion 32 of each terminal 30 may be elastically deformed to come into contact with an adjacent terminal 30, thereby causing a short circuit.

Patent Document 1: Japanese Patent Publication 2004-214091

### BRIEF SUMMARY OF THE INVENTION

The present invention is achieved in view of the above described problem, and has an object to provide a connector that can prevent a short circuit of a terminal when the terminal is elastically deformed with movement of a movable housing.

In order to achieve the object, the present invention provides a connector comprising: a movable housing placed on the side of one object to be connected; a fixed housing placed on the side of the other object to be connected; and a plurality of terminals each having one end held by the movable housing and the other end held by the fixed housing, a movable portion formed at the other end of each terminal being elastically deformed as the movable housing moves relative to the fixed housing in a width direction or a vertical direction, wherein a dimension in a width direction at one end of each terminal is larger than a dimension in the width direction at the other end.

Thus, an interval between the terminals at the other end is larger than an interval between the terminals at one end, thereby preventing adjacent terminals from coming into contact with each other when the movable portions are elastically deformed. This can prevent a short circuit of the terminal when the terminal is elastically deformed with movement of the movable housing.

According to the present invention, the short circuit of the terminal can be prevented when the terminal is elastically deformed with movement of the movable housing, thereby ensuring electrical connection between one object to be connected and the other object to be connected, and allowing signals between a plurality of devices to be stably transmitted. Thus, the plurality of terminals can be placed with high density, so the present invention is advantageously used in small electronic equipment.

### BRIEF DESCRIPTION OF THE DRAWINGS

FIG. 1 is a front perspective view of a connector according to one embodiment of the present invention;

FIG. 2 is a rear perspective view of the connector;

FIG. 3 is a partially enlarged perspective view of the connector;

FIG. 4 is a side sectional view of the connector;

FIG. 5 is a perspective view of a terminal;

FIG. 6 is a plan view of the terminal;

FIG. 7 is a front view of the terminal;

FIG. 8 is a side sectional view of an operation of the connector;

FIG. 9 shows characteristics of a conventional connector and the connector according to one embodiment of the present invention; and

FIG. 10 is a perspective view of a terminal used in the conventional connector.

### DESCRIPTION OF SYMBOLS

11 movable housing
12 fixed housing
20 terminal
22 movable portion
25 contact portion
100 counterpart connector
200 substrate

### DETAILED DESCRIPTION OF THE INVENTION

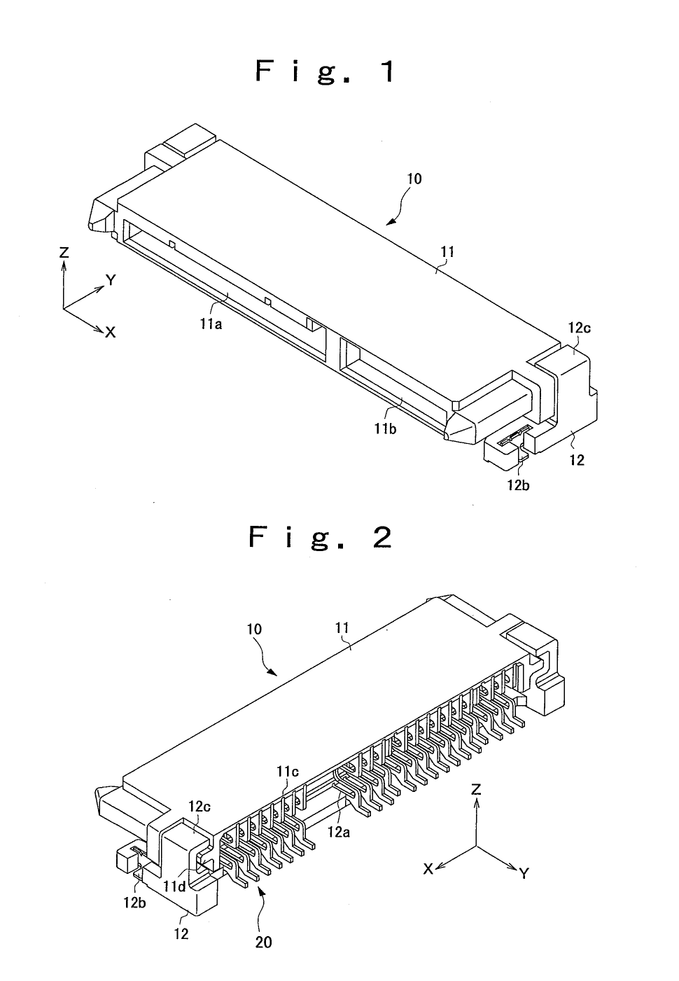

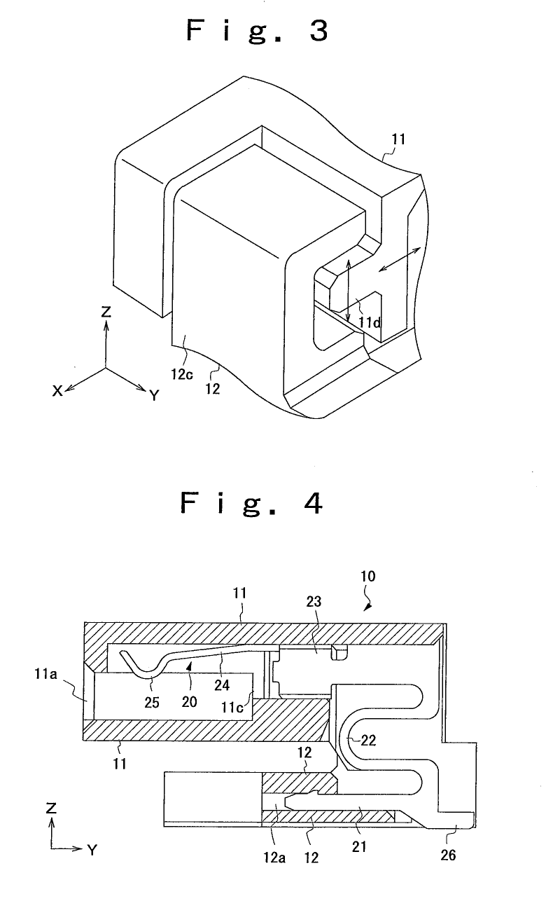

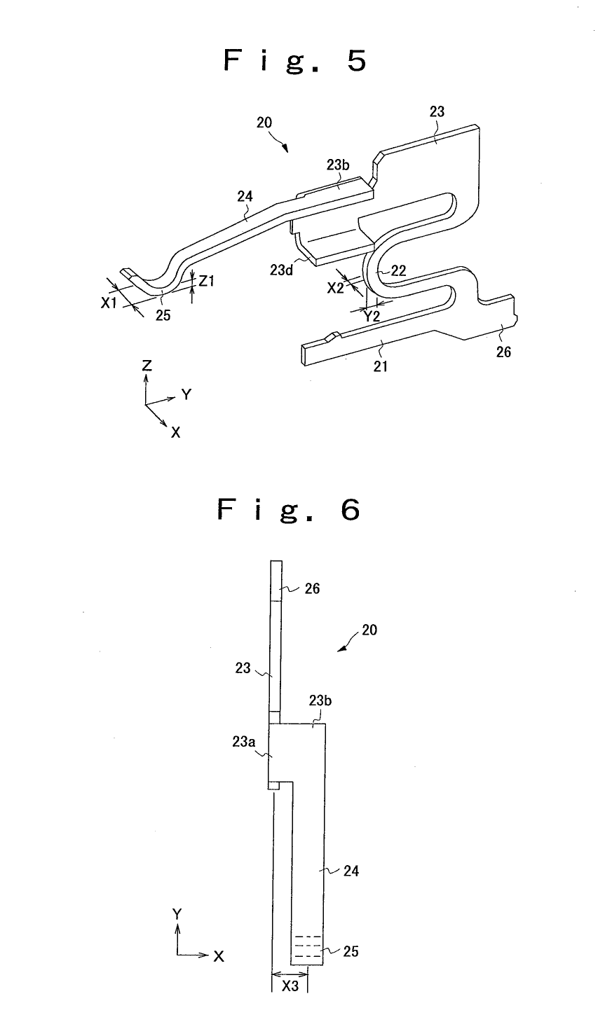

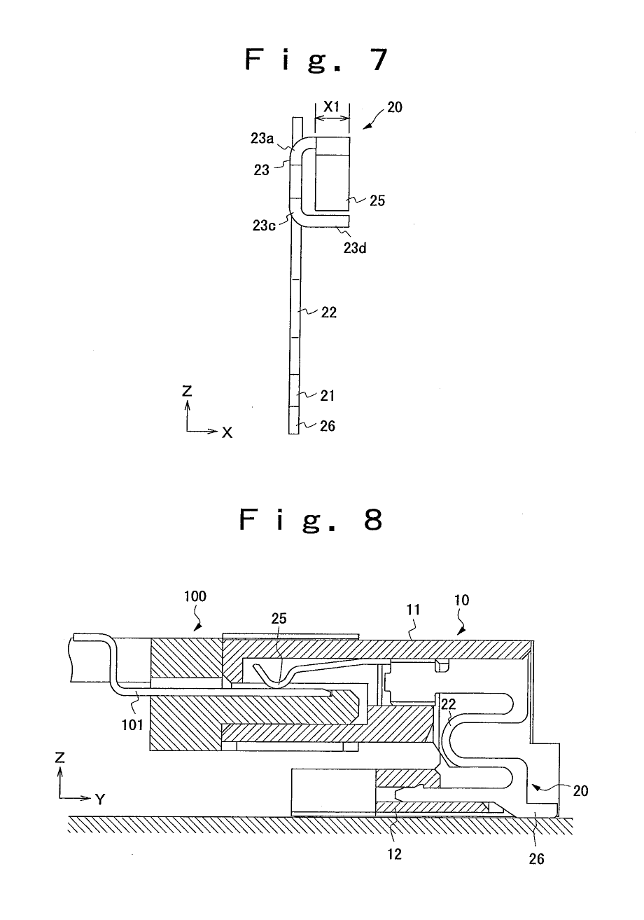

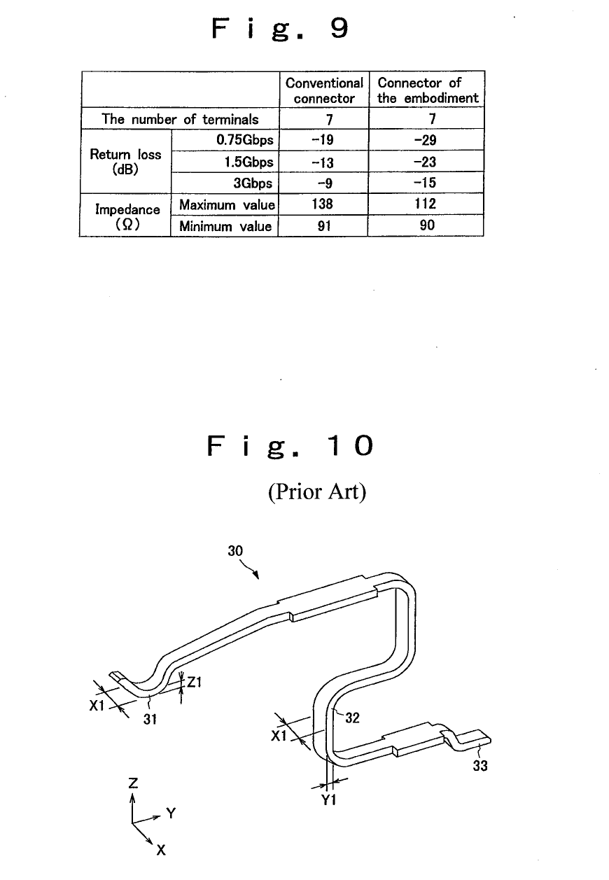

FIGS. 1 to 9 show one embodiment of the present invention, FIG. 1 is a front perspective view of a connector, FIG. 2 is a rear perspective view of the connector, FIG. 3 is a partially enlarged perspective view of the connector, FIG. 4 is a side sectional view of the connector, FIG. 5 is a perspective view of a terminal, FIG. 6 is a plan view of the terminal, FIG. 7 is a front view of the terminal, FIG. 8 is a side sectional view of an operation of the connector, and FIG. 9 shows characteristics of a conventional connector and the connector according to one embodiment of the present invention.

This connector includes a connector body 10, and a plurality of terminals 20 held by the connector body 10, and each terminal 20 has one end coming into contact with a counterpart connector 100 as one object to be connected, and the other end connected to a substrate 200 as the other object to be connected.

The connector body 10 is formed of a synthetic resin molded product, and constituted by a movable housing 11 and a fixed housing 12 that are separately formed and insulating.

The movable housing 11 has, in a front surface, openings 11a and 11b that receive the counterpart connector 100, and a plurality of terminal holes 11c that hold the terminals 20 are provided at regular intervals in a width direction (X direction) in the openings 11a and 11b. Protrusions 11d that fit in the fixed housing 12 are provided at opposite ends in the width direction (X direction) of the movable housing 11.

The fixed housing 12 has a plurality of terminal holes 12a that hold the terminals 20 in the width direction (X direction), and the terminal holes 12a are provided at regular intervals in the width direction (X direction). Connecting portions 12b connected to the substrate 200 are provided at lower portions of opposite side surfaces in the width direction of the fixed housing 12, and locking portions 12c that can lock the protrusions 11d of the movable housing 11 to the fixed housing 12 in a vertical direction (Z direction) and the width direction (X direction) are provided at upper portions of the opposite side surfaces in the width direction of the fixed housing 12. When each protrusion 11d of the movable housing 11 is fitted in each locking portion 12c of the fixed housing 12, spaces in the vertical direction (Z direction) and the width direction (X direction) are formed between each protrusion 11d and each locking portion 12c as shown in FIG. 3, and the movable housing 11 is movable relative to the fixed housing 12 within the range of the spaces.

Each terminal 20 is formed of an elastically deformable conductive metal plate, and has one end held by the movable housing 11 and the other end held by the fixed housing 12. As shown in FIGS. 5 to 7, the terminal 20 includes a holding piece 21 extended forward along the fixed housing 12, a movable portion 22 extended upward from a rear end of the holding piece 21 and bent to protrude forward, a holding portion 23 extended forward from the movable portion 22, a straight portion 24 extended forward from a front end of the holding portion 23, and a contact portion 25 bent downward from a front end of the straight portion 24. A connecting portion 26 connected to the substrate 200 is provided at the other end of the terminal 20, and is formed to protrude rearward of the fixed housing 12 from a lower surface of a rear end of the holding piece 21.

A first bent portion 23a formed to be bent in the width direction (X direction) of the terminal 20 is provided at an upper portion of the front end of the holding portion 23, and the straight portion 24 is provided to extend forward from a first protruding portion 23b formed to protrude in the width direction (X direction) of the terminal 20 by bending the first bent portion 23a. Further, a second bent portion 23c formed to be bent in the width direction (X direction) of the terminal 20, and a second protruding portion 23d protruding from the second bent portion 23c in the width direction (X direction) of the terminal 20 are provided at a lower portion of the front end of the holding portion 23. The first protruding portion 23b is formed to be shifted by a predetermined distance (X3 in the example) in the width direction (X direction) of the terminal 20 relative to the other end of the terminal 20, that is, the holding piece 21, the movable portion 22, and the connecting portion 26. A dimension in the width direction (X direction) at one end of the terminal 20, that is, a dimension in the width direction (X direction) of the first protruding portion 23b, the straight portion 24, and the contact portion 25 is X1 larger than a dimension (=X2) in the width direction at the other end of the terminal 20 . The dimension (=X1) in the width direction at one end of the terminal 20 is larger than a dimension (=Z1) in the vertical direction (Z direction), and the dimension (=X2) in the width direction at the other end of the terminal 20 is smaller than a dimension (=Y2) in a fore/aft direction (Y direction).

One end of the terminal 20 is held by the movable housing 11 by the first protruding portion 23b and the second protruding portion 23d being press fitted into the terminal hole 11c of the movable housing 11, and the other end of the terminal 20 is held by the fixed housing 12 by the holding piece 21 being press fitted into the terminal hole 12a of the fixed housing 12. The terminal 20 is elastically deformed at the movable portion 22 as a base point as the movable housing 11 moves relative to the fixed housing 12 in the width direction (X direction) and the vertical direction (Z direction).

The connecting portion 26 is provided at the other end of the terminal 20, and formed to protrude rearward of the fixed housing 12 from the lower surface of the rear end of the holding piece 21.

The connector thus configured is mounted to a substrate of an interface portion in a device such as an HDD (Hard Disk Drive) or a personal computer compliant with serial ATA standards. As shown in FIG. 8, when the counterpart connector 100 positioned in front of the connector body 10 is inserted into one opening 11a of the movable housing 11, a terminal 101 provided in the counterpart connector 100 comes into contact with the contact portion 25 of the terminal 20. If the counterpart connector 100 moves by a predetermined distance (for example, 0.5 mm) in the width direction (X direction) or the vertical direction (Z direction), each terminal 20 is elastically deformed at the movable portion 22 as a base point as the movable housing 11 moves with the counterpart connector 100.

FIG. 9 shows measured values of return loss for each transmission frequency and maximum and minimum impedances for a conventional connector having a terminal 30 as shown in FIG. 10 and the connector of the embodiment. In this case, the connector of the embodiment apparently has a higher transmission characteristic than the conventional connector because the return loss for each frequency is low and a difference between the maximum impedance and the minimum impedance is small.

The connector of the embodiment also operates as described above when the counterpart connector 100 is inserted into the other opening 11b of the movable housing 11, though the description thereof is omitted.

According to the connector of the embodiment, the dimension (=X1) in the width direction (X direction) at one end of each terminal 20 is larger than the dimension (=X2) in the width direction at the other end, and thus an interval between the terminals 20 at the other end is larger than an interval between the terminals 20 at one end, thereby preventing adjacent terminals 20 from coming into contact with each other when the movable portions 22 are elastically deformed. This prevents a short circuit of the terminal 20 when the terminal 20 is elastically deformed with the movement of the movable housing 11, thereby ensuring electrical connection between the counterpart connector 100 and the substrate 200, and allowing signals between a plurality of devices to be stably transmitted. Thus, the plurality of terminals can be placed with high density, so the connector is advantageously used in small electronic equipment.

The dimension (=X1) in the width direction (X direction) at one end of each terminal 20 is larger than the dimension (=Z1) in the direction (Z direction) perpendicular to the width direction, the dimension (=X2) in the width direction at the other end is smaller than the dimension (=Y2) in the direction (Y direction) perpendicular to the width direction, and thus the dimension in the width direction at the other end becomes much smaller, thereby allowing each terminal 20 to be easily elastically deformed in the width direction (X direction).

Further, one end of each terminal 20 is formed to be shifted by the predetermined distance (X1) relative to the other end in a terminal arranging direction (X direction), thereby allowing a height dimension of the terminal to be reduced while keeping a length of the terminal from one end to the other end, and thus reducing a height of the connector .

Also, one end of each terminal 20 is formed by being bent in the width direction (X direction), and thus each terminal 20 can be easily formed.

In the embodiment, one end of each terminal 20 is formed to be shifted by X1 in the width direction (X direction), but not limited to such a shape, one end of each terminal 20 may be formed to extend forward from an upper portion of the holding portion 23.

In the embodiment, the movable portion 22 of each terminal 20 is formed to be bent to protrude forward, but not limited to such a shape, for example, the movable portion 22 may extend upward without being bent.

1. A connector comprising:
a movable housing on a side of one object to be connected;
a fixed housing on the side of the other object to be connected; and
a plurality of terminals each having one end held by the movable housing and the other end held by the fixed housing,
a movable portion at the other end of each terminal being elastically deformable as the movable housing moves relative to the fixed housing in a width direction or a vertical direction,
wherein the length in a width direction at one end of each of said terminals is larger than the length in the width direction at the other end.

2. The connector according to claim 1, wherein the length in the width direction at one end of said each terminal is larger than a length in a direction perpendicular to the width direction, and the length in the width direction at the other end is smaller than the length in the direction perpendicular to the width direction.

3. The connector according to claim 1, wherein one end of said each terminal is shifted by a predetermined distance in the width direction relative to the other end.

4. The connector according to claim 2, wherein one end of said each terminal is shifted by a predetermined distance in the width direction relative to the other end.

5. The connector according to claim 1, wherein one end of said each terminal is bent in the width direction.

6. The connector according to claim 2, wherein one end of said each terminal is bent in the width direction.

7. The connector according to claim 3, wherein one end of said each terminal is bent in the width direction.
